(19) United States
(12) Patent Application Publication
(10) Pub. No.: US 2018/0339669 A1
(43) Pub. Date: Nov. 29, 2018

(54) SMART CRUISE CONTROL COVER

(71) Applicants: Hyundai Motor Company, Seoul (KR); Kia Motors Corporation, Seoul (KR)

(72) Inventors: So Jung SHIM, Seoul (KR); Byung Kyu CHO, SEOUL (KR); Seung Chan HONG, ANSEONG-SI (KR)

(73) Assignees: Hyundai Motor Company, Seoul (KR); Kia Motors Corporation, Seoul (KR)

(21) Appl. No.: 15/811,229

(22) Filed: Nov. 13, 2017

(30) Foreign Application Priority Data
May 29, 2017 (KR) 10-2017-0065807

(51) Int. Cl. B60R 19/52; B32B 27/06

(52) U.S. Cl. CPC B60R 19/52; B32B 27/06; B60R 2019/525; B32B 2307/418; B32B 2309/105; B32B 2605/00; B32B 2307/41; B32B 2307/412

(57) ABSTRACT

A smart cruise control cover, suitable for attachment to a radiator grill of a vehicle, may include a transparent first resin layer having a contour with a predetermined shape on the rear surface thereof, an opaque second resin layer formed on the rear surface of the first resin layer and having, on the front surface thereof, a contour with a shape corresponding to the shape of the contour formed on the rear surface of the first resin layer, and a three-dimensional viewing layer formed between the first resin layer and the second resin layer and having different visible light reflectances at portions thereof to improve the visibility of the contour formed on each of the rear surface of the first resin layer and the front surface of the second resin layer.

### CROSS REFERENCE TO RELATED APPLICATION

The present application claims priority to Korean Patent Application No. 10-2017-0065807, filed May 29, 2017, the entire content of which is incorporated herein for all purposes by this reference.

### BACKGROUND OF THE INVENTION

### Field of the Invention

The present invention relates to a smart cruise control cover, and more particularly to a smart cruise control cover, which is attached to the radiator of a vehicle.

### Description of Related Art

Typically, a radar for smart cruise control (hereinafter, referred to as “SCC”), suitable for use in a vehicle, is provided to the rear of the radiator of a vehicle.

However, a radiator grill includes metal and may thus cause problems in which incoming and outgoing radio waves may be blocked, and the front of the radar is provided with a smart cruise control cover configured to protect the radar after removal of the radiator grill.

To increase radio-wave permeability, a smart cruise control cover may not be formed of a metal material, and the surface thereof has to be maintained flat, without having large irregularities formed therein. Hence, a black plastic cover without any other pattern may be used.

In the case where such a cover having a simple structure is used, it is very disadvantageous from an aesthetic point of view. To compensate therefor, a structure in which a predetermined pattern is inserted has been provided. Specifically, many attempts have been made to improve both a three-dimensional effect and radio-wave permeability in a manner in which a flat surface is formed by filling a black resin plate, which is opaque and has a contour to form a predetermined pattern, with a transparent resin including polycarbonate.

However, when the cover thus manufactured is observed in practice, the contour thereof is not recognized in three dimensions but appears to be in an opaque and flat form.

Accordingly, there is required a novel cover structure, which is able to represent a specific pattern in three dimensions while having a flat surface so as not to decrease radio-wave permeability.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a smart cruise control cover, which may exhibit a non-metallic three-dimensional texture.

Therefore, various aspects of the present invention are directed to providing a smart cruise control cover, suitable for attachment to the radiator grill of a vehicle, the smart cruise control cover including: a transparent first resin layer having a contour with a predetermined shape on the rear surface thereof, an opaque second resin layer formed on the rear surface of the first resin layer and having, on the front surface thereof, a contour with a shape corresponding to the shape of the contour formed on the rear surface of the first resin layer, and a three-dimensional viewing layer formed between the first resin layer and the second resin layer and having different visible light reflectances at portions thereof to improve the visibility of the contour formed on each of the rear surface of the first resin layer and the front surface of the second resin layer.

The first resin layer may be configured such that a first flat portion having a flat shape and a first contoured portion having a contour are formed on the rear surface thereof, the second resin layer may include, on the front surface thereof, a second flat portion, having a flat shape and formed on a region corresponding to the first flat portion, and a second contoured portion, formed on a region corresponding to the first contoured portion and having a contour having a shape corresponding to the shape of the first contoured portion, the three-dimensional viewing layer may include a flat-textured portion formed between the first flat portion and the second flat portion, and a three-dimensionally textured portion formed between the first contoured portion and the second contoured portion, and the visible light reflectance of the three-dimensionally textured portion is higher than the visible light reflectance of the flat-textured portion.

The visible light reflectance of the three-dimensionally textured portion may be at least 2% p higher than the visible light reflectance of the flat-textured portion.

The visible light reflectance of the three-dimensionally textured portion may range from 7% to 25%.

The three-dimensionally textured portion may include a multilayered optical film formed in the direction in which the first resin layer is disposed and configured such that two or more metal oxides having different refractive indexes are alternately layered, and an opaque first coating layer formed in the direction in which the second resin layer is disposed.

The multilayered optical film may be configured such that a low-refractive-index material including SiO₂ and a high-refractive-index material including TiO₂ are alternately layered.

The multilayered optical film may have a total thickness of 100 nm to 10 μm, and the thickness of each layer of the low-refractive-index material and the high-refractive-index material of the multilayered optical film may be 5 to 200 nm.

The total number of layers of the low-refractive-index material and the high-refractive-index material of the multilayered optical film may be at least 3.

The flat-textured portion may include a black second coating layer formed between the first resin layer and the second resin layer.

The flat-textured portion may further include, between the second coating layer and the second resin layer, a multilayered optical film, configured such that two or more metal oxides having different refractive indexes are alternately layered, and an opaque first coating layer.

The first contoured portion may be formed to be concave, the second contoured portion may be formed to be convex, and the shape defined by the first contoured portion and the second contoured portion may be formed to be continuously connected to the radiator grill.

According to an exemplary embodiment of the present invention, a smart cruise control cover, having a single color, can exhibit a three-dimensional effect.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a front view showing a smart cruise control cover according to an exemplary embodiment of the present invention;

FIG. 2 is a cross-sectional view showing the smart cruise control cover according to the exemplary embodiment of the present invention;

FIG. 3 is a cross-sectional view showing the three-dimensionally textured portion of the smart cruise control cover according to the exemplary embodiment of the present invention;

FIG. 4 and FIG. 5 are cross-sectional views showing the flat-textured portions of smart cruise control covers according to embodiments of the present invention; and

FIG. 6 is of photographs showing whether the three-dimensional (3D) effect and the metallic texture are exhibited depending on variations in reflectance.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The technical terms used herein are merely intended to explain specific examples and are not intended to limit the present invention. Unless otherwise stated, the singular expression includes a plural expression. In this application, the term “include” is used to specify predetermined features, regions, integers, steps, operations, elements, and/or components, and should not be understood as excluding the presence or additional possibility of other predetermined features, regions, integers, steps, operations, elements, components, and/or groups.

Unless defined otherwise, all the terms used in the present specification, including technical and scientific terms, have the same meanings as would be generally understood by those skilled in the related art. The terms defined in generally used dictionaries should be construed as having the same meanings as would be construed in the context of the related art, and unless clearly defined otherwise in the present specification, should not be construed as having idealistic or overly formal meanings.

Hereinafter, a detailed description will be provided of a smart cruise control cover according to exemplary embodiments of the present invention, with reference to the accompanying drawings.

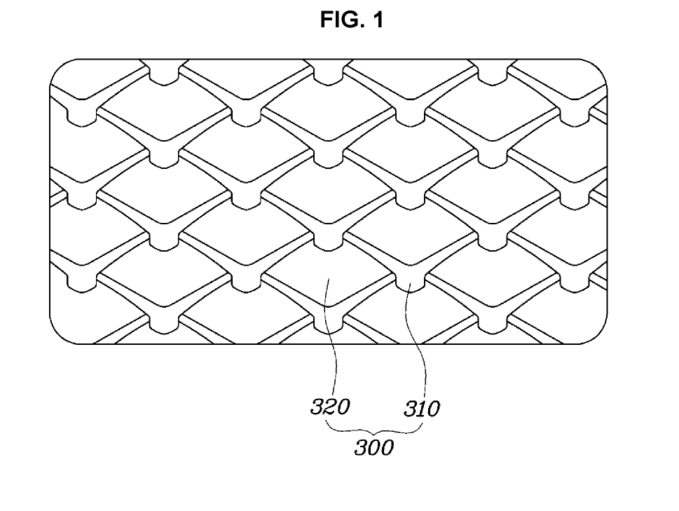

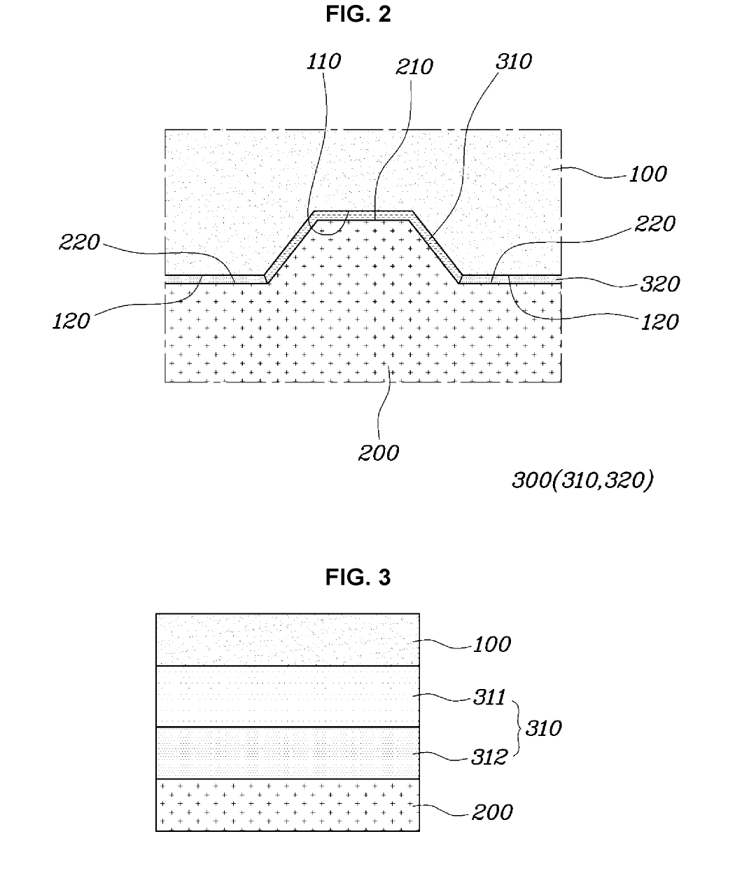

As shown in FIG. 1 and FIG. 2, a smart cruise control cover (hereinafter, referred to as an “SCC cover”) is imparted with an overall uniform color, for example, black. Here, the SCC cover has a three-layer structure configured to include a first resin layer 100, which is transparent and formed at the front thereof, namely the outward direction of a vehicle, a second resin layer 200, which is opaque and formed at the rear thereof, namely the direction in which the radar is disposed, and a three-dimensional viewing layer 300 formed between the first resin layer 100 and the second resin layer 200.

The surface of the first resin layer 100 and the surface of the second resin layer 200, which are in contact with each other, are formed with contours that form a predetermined pattern. Here, a three-dimensional shape may be shown through such contours.

However, even when each of the rear surface of the transparent first resin layer 100 and the front surface of the opaque second resin layer 200 is formed with a contour to ensure a predetermined pattern, in the case where such surfaces are combined with each other, they are perceived as being flat, rather than realizing a three-dimensional effect that may be identified by persons.

Accordingly, provided in an exemplary embodiment of the present invention is a three-dimensional viewing layer 300 having different reflectances at different portions thereof, which is configured such that the contour thereof is recognized in three dimensions. When briefly describing the structure for realizing a three-dimensional effect, the flat portion of the predetermined pattern formed by the contour is controlled so that the reflectance thereof is low, and the three-dimensional portion thereof is controlled so that the reflectance thereof is high, thus exhibiting a three-dimensional effect.

The rear surface of the first resin layer 100 is configured to include a first flat portion 120 having a flat shape and a first contoured portion 110 having a contour, and the front surface of the second resin layer 200 is also configured to include a second flat portion 220 having a flat shape and a second contoured portion 210 having a contour.

The first flat portion 120 and the second flat portion 220 are formed at positions corresponding to each other, the first contoured portion 110 and the second contoured portion 210 are formed at positions corresponding to each other, and the first contoured portion 110 and the second contoured portion 210 are formed to be engaged with each other.

The three-dimensional viewing layer 300 includes a flat-textured portion 320 and a three-dimensionally textured portion 310, and the flat-textured portion 320 is formed between the first flat portion 120 and the second flat portion 220, and the three-dimensionally textured portion 310 is formed between the first contoured portion 110 and the second contoured portion 210.

The reflectance of the three-dimensionally textured portion 310, the reflectance of light in the visible wavelength range of about 400 to 700 nm, should be higher than the reflectance of the flat-textured portion 320.

As the reflectance of the flat-textured portion 320 is lower, the first flat portion 120 and the second flat portion 220 are viewed as empty or flat, and as the reflectance of the three-dimensionally textured portion 310 is higher, the three-dimensional shape of the first contoured portion 110 and the second contoured portion 210 may be recognized more prominently.

To realize such effects, the reflectance of the three-dimensionally textured portion 310 should be controlled to be at least 2% p higher than that of the flat-textured portion 320. When the reflectance difference is less than 2% p, the flat-textured portion 320 and the three-dimensionally textured portion 310 are recognized as being similar, making it difficult to perceive a three-dimensional effect.

Furthermore, the reflectance of the three-dimensionally textured portion 310 is controlled to 7 to 25%, and preferably 10 to 20%.

When the reflectance of the three-dimensionally textured portion 310 is less than 7%, it is difficult to impart the three-dimensionally textured portion 310 with a three-dimensional effect. On the other hand, when the reflectance thereof exceeds 25%, a metallic texture begins to appear, in addition to simply imparting a three-dimensional effect. Hence, the reflectance of the three-dimensionally textured portion 310 has to be controlled to the range of 7 to 25%. To more clearly exhibit the three-dimensional effect of the three-dimensionally textured portion 310, the reflectance thereof is preferably set to 10% or more, and to completely exclude a metallic texture, the reflectance thereof is preferably set to 20% or less.

Although the shapes of the first contoured portion 110 and the second contoured portion 210 are not limited, the first contoured portion 110 is preferably formed to be concave and the second contoured portion 210 is preferably formed to be convex, whereby the shape defined by the first contoured portion 110 and the second contoured portion 210 is formed to be continuously connected to the radiator grill of a vehicle, thus exhibiting a consistent design of the radiator grill and the SCC cover, resulting in an aesthetic detect of unity.

As shown in FIG. 3, the three-dimensionally textured portion 310 includes a multilayered optical film 311 and a first coating layer 312, and the multilayered optical film 311 is formed by alternately layering two or more different kinds of metal oxides, and the first coating layer 312 is formed of an opaque paint, and preferably a black paint.

The metal oxides that form the multilayered optical film 311 may include, for example, a low-refractive-index material including SiO₂ and a high-refractive-index material including TiO₂ which are layered alternately.

The low-refractive-index material including SiO₂ is configured to brighten the color of the light reflected from the multilayered optical film 311 and to increase the durability of the multilayered optical film 311 because of high scratch resistance.

The high-refractive-index material including TiO₂ is highly adhered to a base substrate, thus preventing the multilayered optical film 311 and the first resin layer 100 from being stripped from each other.

The ceramic materials or metal oxides including SiO₂ or TiO₂ have high radio-wave permeability and superior durability and corrosion resistance, and high reflectance may be achieved by alternately layering the low-refractive-index material and the high-refractive-index material.

Exemplary embodiments of the low-refractive-index material and the high-refractive-index material are not limited to the foregoing. For instance, the low-refractive-index material may be Al₂O₃ and the high-refractive-index material may be Cr₂O₃. In the present way, two materials having different refractive indexes may be layered alternately.

Although the factors that determine the reflectance of the multilayered optical film 311 are various, the reflectance may be controlled depending on the number of layers in which the low-refractive-index material and the high-refractive-index material are alternately layered, the thickness of each layer, and the total thickness.

The reflectance required of the three-dimensionally textured portion 310 in which the multilayered optical film 311 is provided is 7 to 25%. To satisfy such a reflectance, the total thickness of the multilayered optical film 311 is set to the range of 100 nm to 10 μm, and the thickness of each layer of the low-refractive-index material and the high-refractive-index material of the multilayered optical film 311 is set to the range of 5 to 200 nm, and the total number of layers of the low-refractive-index material and the high-refractive-index material is controlled to 3 or more.

When the total thickness of the multilayered optical film 311 is less than 100 nm, the desired reflectance cannot be obtained. On the other hand, when the total thickness thereof exceeds 10 μm, reflectance becomes too high, and a bonding force between the first resin layer 100 and the second resin layer 200 may decrease.

When the thickness of each layer of the low-refractive-index material and the high-refractive-index material is less than 5 nm, it is difficult to perform a deposition layering process. On the other hand, when the thickness thereof exceeds 200 nm, interlayer delamination may occur.

When the total number of layers of the low-refractive-index material and the high-refractive-index material is less than 3, it is difficult to realize the desired reflectance.

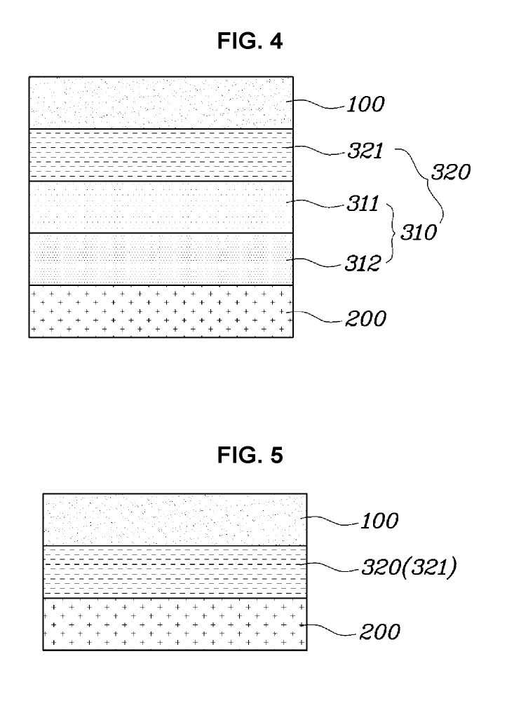

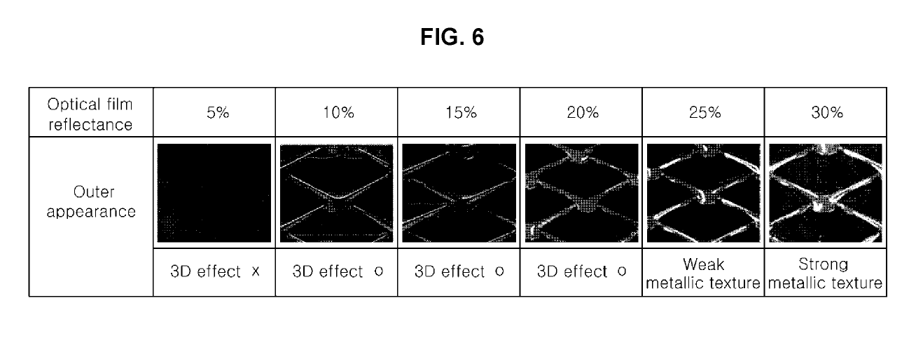

As shown in FIG. 4 and FIG. 5, the flat-textured portion 320 may be composed exclusively of a black second coating layer 321, and may further include a three-dimensionally textured portion 310, in addition to the second coating layer 321.

Although it will be described later in the method of manufacturing the SCC cover according to an exemplary embodiment of the present invention, for convenience of the formation thereof, the flat-textured portion 320 is preferably including the second coating layer 321, the multilayered optical film 311 and the first coating layer 312.

The second coating layer 321 is a key component of the flat-textured portion 320 and is substantially disposed directly after the first resin layer 100, and includes a black paint having a reflectance of 6% or less. When the second coating layer 321 is provided, the rear configuration thereof, for example, the second resin layer 200, does not appear.

Below is a description of the method of manufacturing the SCC cover according to an exemplary embodiment of the present invention.

As shown in FIGS. 1 to 4 and 5, in an exemplary embodiment of the present invention, a transparent first resin layer 100 is manufactured using an injection process or the like. The material for the first resin layer 100 is a resin which is transparent and has high radio-wave permeability, for example, polycarbonate or acrylic resin.

Provided on the rear surface of the first resin layer 100 is a three-dimensional viewing layer 300 including a flat-textured portion 320 and a three-dimensionally textured portion 310. Here, the flat-textured portion 320 is formed first.

The rear surface of the first resin layer 100 is formed with a first flat portion 120 and a first contoured portion 110. A second coating layer 321 of a flat-textured portion 320 is formed on the first flat portion 120. Here, the second coating layer 321 may be partially formed by separately masking the first contoured portion 110, or alternatively, after the completion of the formation of the second coating layer 321 on the rear surface of the first resin layer 100, the second coating layer 321 may be removed from the first contoured portion 110. The second coating layer 321 is formed of a material having very low reflectance, for example, a black paint.

After the completion of the formation of the second coating layer 321, the three-dimensionally textured portion 310 is formed. The three-dimensionally textured portion 310 is configured such that a multilayered optical film 311 and a first coating layer 312 are sequentially formed.

A first resin layer 100 is fixed within a deposition coating device, and a plasma state is made using Ar gas in a vacuum, after which a bias is applied thereto so that the rear surface of the first resin layer 100 is pretreated by being cleaned and simultaneously activated.

Thereafter, an e-beam is alternately radiated onto a TiO₂ sample and a SiO₂ sample provided inside the deposition coating device, whereby the multilayered optical film 311 is formed on the rear surface of the first resin layer 100.

The multilayered optical film 311 may not be formed on the region where the second coating layer 321 is provided, but to partially form the multilayered optical film 311, separately masking the region where the second coating layer 321 is provided has to be additionally performed, and thus the formation of the multilayered optical film 311 on the region where the second coating layer 321 is provided is regarded as preferable.

The multilayered optical film 311 is formed of a metal oxide having high radio-wave permeability, for example, a ceramic, whereby reflectance may increase to thus realize a three-dimensional effect, and radio waves for use in SCC may not decay.

After the formation of the multilayered optical film 311, a first coating layer 312 that covers the multilayered optical film 311 is provided. Since the first coating layer 312 may be less black than the second coating layer 321, the first coating layer 312 may not be formed on the first flat portion 120, but a masking process that blocks the formation thereof on the specific region should be additionally conducted, as in the multilayered optical film 311, and thus the second coating layer 321 is preferably formed on the entire area, like the multilayered optical film 311.

Finally, an opaque second resin layer 200 is formed using an injection process so that the rear surface of the SCC cover becomes flat. Any material may be used for the second resin layer 200 when it is opaque and has high radio-wave permeability, and it may be exemplified by ASA (Acrylic Styrene Acrylonitrile).

The second resin layer 200 is preferably black-colored, and may be formed through a double injection process on the first resin layer 100 on which the three-dimensional viewing layer 300 is formed.

Any configuration which is connected to the radar for SCC or other peripheral members may be formed on the rear surface of the second resin layer 200.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A smart cruise control cover, for attachment to a radiator grill of a vehicle, the smart cruise control cover comprising:
a first resin layer, which is transparent and has a contour with a predetermined shape on a rear surface thereof;
a second resin layer, which is opaque, is formed on the rear surface of the first resin layer, and has, on a front surface thereof, a contour with a shape corresponding to the shape of the contour formed on the rear surface of the first resin layer; and
a three-dimensional viewing layer formed between the first resin layer and the second resin layer and having different visible light reflectances to improve a visibility of the contour formed on each of the rear surface of the first resin layer and the front surface of the second resin layer.

2. The smart cruise control cover of claim 1, wherein the first resin layer is configured such that a first flat portion having a flat shape and a first contoured portion having a contour are formed on the rear surface thereof,
the second resin layer includes, on the front surface thereof, a second flat portion having a flat shape and formed on a region corresponding to the first flat portion, and a second contoured portion formed on a region corresponding to the first contoured portion and having a contour having a shape corresponding to a shape of the first contoured portion,
the three-dimensional viewing layer includes a flat-textured portion formed between the first flat portion and the second flat portion, and a three-dimensionally textured portion formed between the first contoured portion and the second contoured portion, and
a visible light reflectance of the three-dimensionally textured portion is higher than a visible light reflectance of the flat-textured portion.

3. The smart cruise control cover of claim 2, wherein the visible light reflectance of the three-dimensionally textured portion is at least 2% p greater than the visible light reflectance of the flat-textured portion.

4. The smart cruise control cover of claim 2, wherein the visible light reflectance of the three-dimensionally textured portion ranges from 7% to 25%.

5. The smart cruise control cover of claim 4, wherein the three-dimensionally textured portion includes a multilayered optical film formed in a direction in which the first resin layer is disposed and configured such that two or more metal oxides having different refractive indexes are alternately layered, and an opaque first coating layer formed in a direction in which the second resin layer is disposed.

6. The smart cruise control cover of claim 5, wherein the multilayered optical film is configured such that a low-refractive-index material including SiO₂ and a high-refractive-index material including TiO₂ are alternately layered.

7. The smart cruise control cover of claim 6, wherein the multilayered optical film has a total thickness of 100 nm to 10 μm, and a thickness of each layer of the low-refractive-index material and the high-refractive-index material of the multilayered optical film is 5 to 200 nm.

8. The smart cruise control cover of claim 7, wherein a total number of layers of the low-refractive-index material and the high-refractive-index material of the multilayered optical film is at least 3.

9. The smart cruise control cover of claim 2, wherein the flat-textured portion includes a black second coating layer formed between the first resin layer and the second resin layer.

10. The smart cruise control cover of claim 9, wherein the flat-textured portion further includes, between the second coating layer and the second resin layer, a multilayered optical film, configured such that two or more metal oxides having different refractive indexes are alternately layered, and an opaque first coating layer.

11. The smart cruise control cover of claim 2, wherein the first contoured portion is formed to be concave, the second contoured portion is formed to be convex, and a shape defined by the first contoured portion and the second contoured portion is formed to be continuously connected to the radiator grill.
